(19) United States
(12) Patent Application Publication
(10) Pub. No.: US 2013/0287342 A1
(43) Pub. Date: Oct. 31, 2013

(54) LEAD-IN FORMATIONS IN OPTICAL FIBER SEGMENTS AND METHODS OF FORMING LEAD-IN FORMATIONS

(71) Applicants: Paulo Clóvis Dainese Júnior, Painted Post, NY (US); Micah Colen Isenhour, Lincolnton, NC (US); Dennis Michael Knecht, Hickory, NC (US); James Phillip Luther, Hickory, NC (US); Robert Stephen Wagner, Corning, NY (US)

(72) Inventors: Paulo Clóvis Dainese Júnior, Painted Post, NY (US); Micah Colen Isenhour, Lincolnton, NC (US); Dennis Michael Knecht, Hickory, NC (US); James Phillip Luther, Hickory, NC (US); Robert Stephen Wagner, Corning, NY (US)

(21) Appl. No.: 13/459,888

(22) Filed: Apr. 30, 2012

(51) Int. Cl. G02B 6/36; B23K 26/00

(52) U.S. Cl. 385/77; 219/121.85

(57) ABSTRACT

An optical fiber segment includes a glass body with a first end face at a first end of the glass body and a second end face at a second end of the glass body. At least one of the first and second end faces includes a lead-in formation having a sidewall extending inwardly from an entrance at the at least one first and second end faces to an end, the entrance sized to at least partially receive a tip of an optical fiber.

### FIELD

The technology of the disclosure relates to optical fiber segments such as gradient index (GRIN) lenses and, more particularly to optical fiber segments having lead-in formations for receiving an end of an optical fiber.

### BACKGROUND

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support optical fiber interconnections.

Fiber optic connectors are provided to facilitate optical connections with optical fibers for the transfer of light. For example, optical fibers can be optically connected to another optical device, such as a light-emitting diode (LED), laser diode, or opto-electronic device for light transfer. As another example, optical fibers can be optically connected to other optical fibers through mated fiber optic connectors. In any of these cases, it is important that the end face of an optically connected optical fiber be precisely aligned with the optical device or other optical fiber to avoid or reduce coupling loss. For example, the optical fiber is disposed through a ferrule that precisely locates the optical fiber with relation to the fiber optic connector housing.

Gradient index (GRIN) lenses offer an alternative to mechanically polishing very accurate arrays of fibers. GRIN lenses focus light through a precisely controlled radial variation of the lens material's index of refraction from the optical axis to the edge of the lens. The internal structure of this index gradient can dramatically reduce the need for tightly controlled fiber array tolerances and results in a simple, compact lens. This allows a GRIN lens with flat surfaces to collimate light emitted from an optical fiber or to focus an incident beam into an optical fiber. The GRIN lens can be provided in the form of a glass rod that is disposed in a lens holder as part of a fiber optic connector. The flat surfaces of a GRIN lens allow easy bonding or fusing of one end to an optical fiber disposed inside the fiber optic connector with the other end of the GRIN lens disposed on the ferrule end face. The flat surface on the end face of a GRIN lens can reduce aberrations, because the end faces can be polished to be planar or substantially planar to the end face of the ferrule. The flat surface of the GRIN lens allows for easy cleaning of end faces of the GRIN lens.

### SUMMARY

In one embodiment, an optical fiber segment includes a glass body with a first end face at a first end of the glass body and a second end face at a second end of the glass body. At least one of the first and second end faces includes a lead-in formation having a sidewall extending inwardly from an entrance at the at least one first and second end faces to an end, the entrance sized to at least partially receive a tip of an optical fiber.

In another embodiment, a fiber assembly includes an optical fiber segment comprising a glass body, a first end face at a first end of the glass body and a second end face at a second end of the glass body. At least one of the first and second end faces includes a lead-in formation having a sidewall extending inwardly from an entrance at the at least one first and second end faces to an end. The entrance is sized to at least partially receive a tip of an optical fiber. An optical fiber has a tip at least partially located in the lead-in formation.

In another embodiment, a method of forming an optical fiber segment is provided. The method includes directing a laser beam onto an end face of the optical fiber segment. A lead-in formation is formed having a sidewall extending inwardly from an entrance at the end face using the laser beam. The entrance is sized to at least partially receive a tip of an optical fiber.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

FIG. 1 is a perspective view of an exemplary cable plug employing a gradient index (GRIN) lens holder comprised of a seamless lens holder body employing internal groove alignment features for securing and aligning GRIN lenses;

FIG. 2 is a close-up perspective view of the GRIN lens holder of the plug in FIG. 1 with GRIN lenses;

FIG. 3 illustrates an embodiment of a fiber assembly including a GRIN lens including a lead-in formation;

FIG. 3A is an end view of the GRIN lens of FIG. 3;

FIG. 4 is another embodiment of a fiber assembly including a GRIN lens including a lead-in formation; and

FIG. 5 is a schematic illustration of an embodiment of a process of forming a lead-in formation for a GRIN lens.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments described herein generally relate to optical fiber segments such as gradient index (GRIN) lenses including lead-in formations formed in one or both end faces of the optical fiber segments. In some instances, the lead-in formations are formed in only one end face of the optical fiber segments. The lead-in formations may be formed within the optical fiber segments, themselves, and may be used in aligning a tip of an optical fiber with a centerline (or other desired alignment) of the optical fiber segments. The tips of the optical fibers may have alignment formations that can mate or otherwise cooperate with the lead-in formations of the optical fiber segments to provide the desired alignment therebetween. Such lead-in formations can provide for mechanical alignment between the optical fiber segments and their associated optical fibers. While GRIN lenses are discussed below, other optical fiber segments, such as multimode fiber segments may include the lead-in formations where the optical fiber segments behave in a fashion similar to that of GRIN lenses.

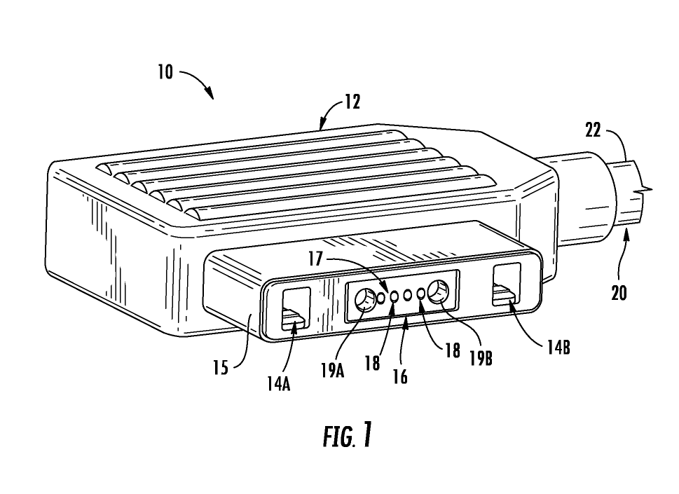

Referring to FIG. 1, a perspective view of an exemplary connector 10 employing a GRIN lens holder configured to support and align GRIN lenses. The connector 10 in this embodiment is provided in the form of a plug 12. For example, the plug 12 may be a fiber optic connection plug that exclusively supports optical components for establishing optical connections. Alternatively, the plug 12 may also include electrical components, such as power conductors 14A, 14B disposed in the plug 12 for establishing electrical connections, as a non-limiting example.

With continuing reference to FIG. 1, the plug 12 in this embodiment employs a GRIN lens holder 16 to support optical components for establishing optical connections. The GRIN lens holder 16 is disposed in a connector housing 15 of the plug 12. The GRIN lens holder 16 could be disposed in a ferrule 17 that is disposed in the connector housing 15, as an example. The GRIN lens holder 16 is configured to support and align one or more GRIN lenses 18 disposed in the GRIN lens holder 16. For example, the GRIN lens holder 16 disposed in the plug 12 in FIG. 1 is configured to support up to four (4) GRIN lenses.

The GRIN lenses 18 may be optically coupled or fused to optical fibers 20 disposed in a cable 22 secured to the plug 12. As will be described in greater detail below, the GRIN lenses 18 may include lead-in formations to facilitate the coupling and alignment between the GRIN lenses 18 and the optical fibers 20. In this manner, an optical connection made to the GRIN lenses 18 disposed in the GRIN lens holder 16 through a mating of the plug 12 to a receptacle or other optical component establishes an optical connection to the optical fibers 20. Alignment openings 19A, 19B are disposed in the plug 12 to assist in alignment of the plug 12 to a receptacle when the plug 12 is mated to a receptacle.

The GRIN lenses 18 disposed in the GRIN lens holder 16 of the plug 12 can offer an alternative to polishing highly accurate array tolerances onto the ends of optical fibers 20. The GRIN lenses 18 focus light through a precisely controlled radial variation of the lens material's index of refraction from the optical axis to the edge of the lens. The internal structure of this index gradient can dramatically reduce the need for tightly controlled surface curvatures and results in a simple, compact lens. This allows the GRIN lenses 18 to collimate light emitted from the optical fibers 20 or to focus an incident beam into the optical fibers 20.

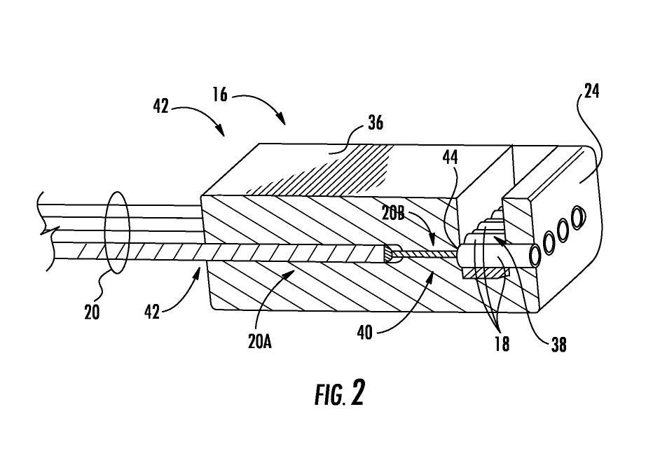

In this regard, FIG. 2 is a perspective view of the GRIN lens holder 16 of the plug 12 of FIG. 1. The GRIN lens holder 16, as one example, can be mated at mating surface 24 to optically connect the GRIN lenses 18 disposed in the GRIN lens holder 16 with GRIN lenses disposed in another GRIN lens holder. The GRIN lens holder 16, in this embodiment, is comprised of a lens holder body 36. An internal chamber 38 is disposed in the lens holder body 36. The GRIN lenses 18 are disposed and arranged in the internal chamber 38. The GRIN lenses 18 can be fused or optically connected to end portions 40 of bare optical fiber portions 20A of coated optical fiber portions 20B of the optical fibers 20 disposed in the internal chamber 38. For example, the bare optical fiber portions 20A may be fifty (50), one-hundred (100), one hundred twenty-five (125) micrometers (μm) or more in diameter, and the coated optical fiber portions 20B may be up to two hundred fifty (250) μm or more in diameter, as non-limiting examples. To provide for the end portions 40 of the optical fibers 20 to be disposed in the internal chamber 38 of the lens holder body 36, light port openings 42 are disposed in the lens holder body 36. The light port openings 42 are coupled to the internal chamber 38. For example, the light port openings 42 may be holes disposed in the lens holder body 36. The end portions 40 of the optical fibers 20 can be inserted into the light port openings 42 to be optically connected or fused to end faces 44 of the GRIN lenses 18 for optical connection.

While FIG. 2 illustrates the GRIN lens holder 16 including four GRIN lenses 18, there may be GRIN holders that include many more than four GRIN lenses. In any event, it may be desirable to provide the GRIN lenses 18 with lead-in formations that can aid in the precise alignment of the optical fibers 20 with the GRIN lenses 18 when optically connecting the optical fibers 20 to the GRIN lenses 18.

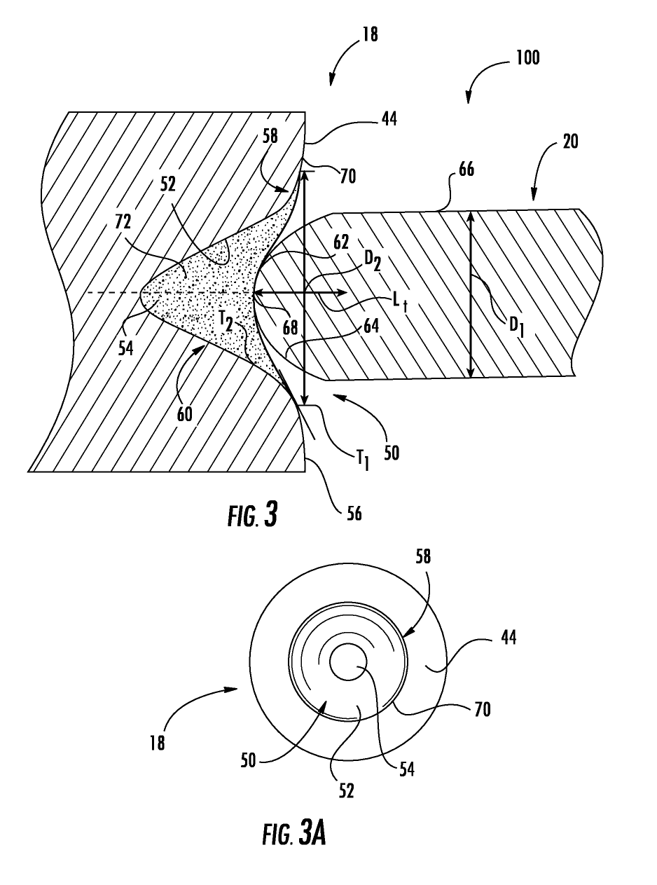

Referring to FIG. 3, the GRIN lens 18 includes the end face 44 including a lead-in formation 50 extending inwardly into the GRIN lens 18 from the end face 44. The lead-in formation 50 may be the form of a recess having an internally extending sidewall 52 that extends inwardly to an end 54. FIG. 3A also shows the end face 44 of the GRIN lens 18 with the lead-in formation 50 including the sidewall 52 and the end 54. As can be seen by FIG. 3, the sidewall 52 extends inwardly from an end surface 56 of the end face 44 to the end 54. In some embodiments, the sidewall 52 may have a somewhat rounded entry portion 58 and a somewhat straight or less rounded intermediate portion 60 that leads to the end 54 (e.g., forming a somewhat parabolic shape). In some embodiments, the entry portion 58 may have a tangent T₁ having a slope that is greater than a slope of a tangent T₂ within the intermediate portion 60. Such a greater slope at the entry portion 58 of the lead-in formation 50 can serve to guide a tip 62 of the optical fiber 20 into the lead-in formation 50. In other embodiments, the slopes at the entry portion 58 and the intermediate portion 60 may be about the same or the slope at the intermediate portion 60 may be greater than the slope at the entry portion 58. Additionally, while the entry portion 58 is illustrated as being rounded, the entry portion 58 may be substantially straight and form part of a somewhat V-shaped lead-in formation. Additionally, while the sidewall 52 is illustrated as being generally smooth, arrays of microfeatures (not shown) may be formed in the sidewall 52.

The optical fiber 20 includes the tip 62 that is sized to be received within the lead-in formation 50. In the illustrated embodiment, the tip 62 is somewhat rounded in shape having a tip periphery 64 that extends from a sidewall 66 of the optical fiber 20 to an end 68. In some embodiments, an outer diameter D₁ (or width) of the optical fiber 20 is less than a maximum diameter D₂ (or width) of the lead-in formation 50 at an entrance 70 of the lead-in formation 50. In some embodiments, for example, D₁ may be about 95 percent or less of D₂, such as about 85 percent or less of D₂, such as 75 percent or less of D₂, such as 65 percent or less of D₂, such as 50 percent or less of D₂.

FIG. 3 illustrates a first fiber assembly 100 with the GRIN lens 18 and optical fiber 20 optically coupled thereto using an index matching adhesive 72. In some embodiments, the tip 64 of the optical fiber 20 may be spaced from the sidewall 66. In some embodiments, only a portion of the tip 64 may be located within the lead-in formation 50. The tip 64 of the optical fiber 20 refers to the portion at the end of the optical fiber 20 extending inwardly from the sidewall 66 toward a center axis of the optical fiber 20. For example, for a tip 64 having a length Lt, only about 90 percent or less, such about 75 percent or less, such as about 50 percent or less of the length Lt of the tip 64 may be located in the lead-in formation 50. In other embodiments, the entire tip 64 may be located in the lead-in formation 50.

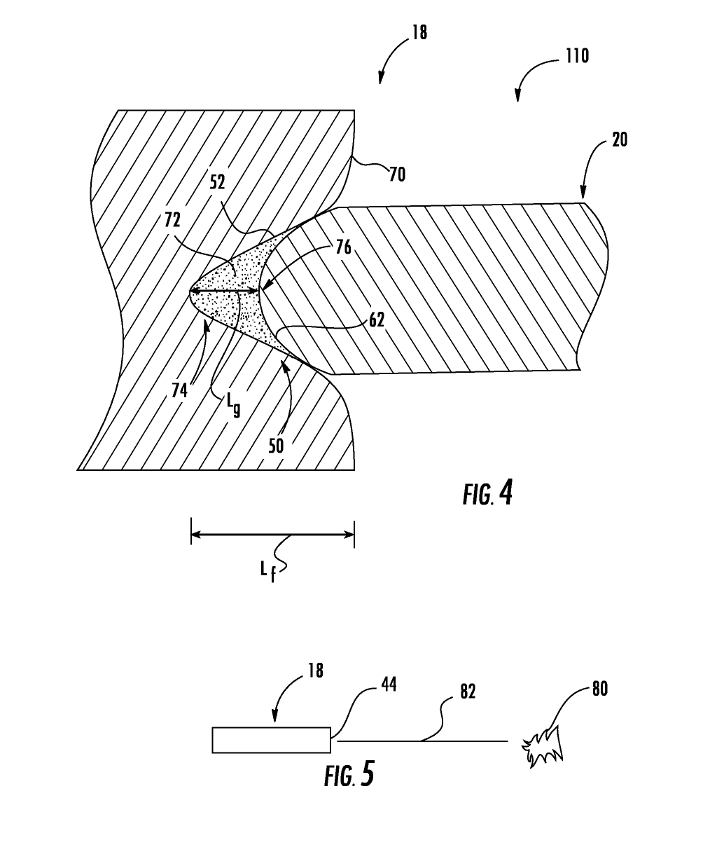

Referring to FIG. 4, another fiber assembly 110 includes the optical fiber 20 butted with the GRIN lens 18 within the lead-in formation 50. In this embodiment, the tip 62 contacts or otherwise engages the sidewall 52 of the lead-in formation 50. An index matching adhesive 72 may be used to hold the optical fiber 20 within the lead-in formation 50. In some embodiments, the optical fiber 20 may be mechanically held in place within the lead-in formation 50 and an index matching gel may be used in optically coupling the optical fiber 20 and the GRIN lens 18.

As can be seen by FIGS. 3 and 4, the tip 62 of the optical fiber 20 may extend only partially within the lead-in formation 50 thereby providing a gap 74 between the end 54 and an outermost region 76 of the tip 64. For example, referring to FIG. 4, a length Lg of the gap 74 from the end 54 to the tip 64 may be about 75 percent or less than a total length Lf of the lead-in formation 50 from the end 54 to the entrance 70, such as about 50 percent or less, such as about 40 percent or less, such as about 25 percent or less.

FIG. 5 is a schematic diagram illustrating a laser forming process for forming the lead-in formation 50 in the end face 44 of the GRIN lens 18. In this example, a laser source 80 (e.g., a CO₂ laser) provides a laser beam 82 that is directed onto the end face 44 of the GRIN lens 18. The laser beam 82 may be directed along a central axis of the GRIN lens 18, and/or the laser beam 82 may be directed toward the end face 44 at an angle to the central axis of the GRIN lens 18, depending on the desired end shape of the lead-in formation 50. Size of the lead-in formation 50 may be controlled, at least in part, by selection of spot size, laser power and pulses. For example, use of a low power CO₂ (e.g., about 10 W or less) when combined with a 1/e² spot size on the order of 80 microns (+/−20 microns) and controlling the number of pulses (1-100) may be implemented to produce the desired lead-in formation characteristics. Higher power systems may be used by reducing the number of pulses and/or use of a beam dump to control the delivered pulse energy to the GRIN lens 18. Other methods may be used to form the lead-in formations, such as use of short wavelength lasers to drill a lead-in formation. Use of a CO₂ laser can naturally produce a parabolic depression in the end face 44 of the GRIN lens 18 if used in a highly ablative cut regime. Additionally, the tip 62 of the optical fiber 20 may be cleaved (e.g., using a CO₂ laser) in a process pushed toward a melt regime, causing the tip 62 to be rounded as illustrated by FIGS. 3 and 4. Or, the fiber tip can be pulled while heating and then cleaved to produce a tip with a geometry largely matching the cavity in the GRIN lens.

As non-limiting examples, the GRIN lenses disclosed herein may comprise a generally cylindrical glass member having a radially varying index of refraction, the glass member having a length such that the lens has a pitch of less than about 0.23. As used herein, the pitch length of the lens, Lo, is 2π/A; the fractional pitch, or, hereafter, pitch, is L/Lo=LA/2π, where L is the physical length of the lens. In various embodiments, the pitch is between about 0.08 and 0.23, such as, for example, lenses having pitches of 0.22, 0.21, 0.20, 0.19, 0.18, 0.17, 0.16, 0.15, 0.14, 0.13, 0.12, 0.11, 0.10, 0.09 and 0.08. Some embodiments relate to small diameter lenses, such as lenses having a diameter less than or equal to about one (1) mm, for example, 0.8 mm. In certain embodiments, lenses having a diameter less than about 1 mm are operative to produce a beam having a mode field diameter between about 350 μm and 450 μm when illuminated with a beam having a mode field diameter of about 10.4 μm.

Examples of optical devices that can interface with the GRIN lenses disclosed in the GRIN lens holders disclosed herein include, but are not limited to, fiber optic collimators, DWDMs, OADMs, isolators, circulators, hybrid optical devices, optical attenuators, MEMs devices, and optical switches.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. An optical fiber segment comprising:
a glass body;
a first end face at a first end of the glass body; and
a second end face at a second end of the glass body;
wherein at least one of the first and second end faces includes a lead-in formation having a sidewall extending inwardly from an entrance at the at least one first and second end faces to an end, the entrance sized to at least partially receive a tip of an optical fiber.

2. The optical fiber segment of claim 1, wherein the sidewall includes an entry portion and an intermediate portion that leads to an end of the lead-in structure disposed within the glass body.

3. The optical fiber segment of claim 2, wherein the entry portion of the sidewall is rounded.

4. The optical fiber segment of claim 3, wherein the intermediate portion of the sidewall is less rounded than the entry portion of the sidewall.

5. The optical fiber segment of claim 1, wherein the glass body has a radially varying index of refraction.

6. The optical fiber segment of claim 5, wherein the glass body includes a gradient index (GRIN) lens.

7. The optical fiber segment of claim 1, wherein the shape of the entrance to the lead-in structure is round.

8. A fiber assembly comprising:
an optical fiber segment comprising:
a glass body;
a first end face at a first end of the glass body; and
a second end face at a second end of the glass body;
wherein at least one of the first and second end faces includes a lead-in formation having a sidewall extending inwardly from an entrance at the at least one first and second end faces to an end, the entrance sized to at least partially receive a tip of an optical fiber; and
an optical fiber having a tip at least partially located in the lead-in formation.

9. The fiber assembly of claim 8, wherein the sidewall of the lead-in formation includes an entry portion and an intermediate portion that leads to an end of the lead-in structure disposed within the glass body.

10. The fiber assembly of claim 9, wherein the entry portion of the sidewall is rounded.

11. The fiber assembly of claim 10, wherein the intermediate portion of the sidewall is less rounded than the entry portion of the sidewall.

12. The fiber assembly of claim 10, wherein the glass body has a radially varying index of refraction.

13. The optical fiber segment of claim 12, wherein the glass body includes a gradient index (GRIN) lens.

14. The fiber assembly of claim 10, wherein the shape of the entrance to the lead-in structure is round.

15. The fiber assembly of claim 10, wherein the tip of the optical fiber is spaced from the sidewall of the lead-in formation.

16. The fiber assembly of claim 15, wherein an index matching adhesive bonds the tip of the optical fiber within the lead-in formation.

17. The fiber assembly of claim 10, wherein the tip of the optical fiber abuts the sidewall of the lead-in formation.

18. The fiber assembly of claim 10, wherein the tip of the optical fiber is only partially located within the lead-in formation.

19. A method of forming an optical fiber segment, the method comprising:
directing a laser beam onto an end face of the optical fiber segment; and
forming a lead-in formation having a sidewall extending inwardly from an entrance at the end face using the laser beam, the entrance sized to at least partially receive a tip of an optical fiber.

20. The method of claim 19, wherein the step of forming the lead-in formation includes forming the sidewall including an entry portion and an intermediate portion that leads to an end of the lead-in structure.

21. The method of claim 19, wherein the optical fiber segment has a radially varying index of refraction.

22. The method of claim 19 comprising generating the laser beam using a CO2 laser source.
